(19) United States
(12) Patent Application Publication
(10) Pub. No.: US 2026/0187882 A1
(43) Pub. Date: Jul. 2, 2026

(54) INFORMATION PROCESSING APPARATUS, INFORMATION PROCESSING METHOD, PROGRAM, AND INFORMATION PROCESSING SYSTEM

(71) Applicant: FUJIFILM Corporation, Tokyo (JP)

(72) Inventor: Shinji HAYASHI, Tokyo (JP)

(73) Assignee: FUJIFILM Corporation, Tokyo (JP)

(21) Appl. No.: 19/543,948

(22) Filed: Feb. 19, 2026

Related U.S. Application Data
(63) Continuation of application No. PCT/JP2024/025562, filed on Jul. 17, 2024.

(30) Foreign Application Priority Data
Aug. 23, 2023 (JP) 2023-135725

(51) Int. Cl. G06T 11/65; G06T 7/30; G06T 7/70; G06V 10/70; G06V 20/10

(52) U.S. Cl. CPC G06T 11/65; G06T 7/30; G06T 7/70; G06V 10/70; G06V 20/176; G06T 2207/20081; G06T 2207/30184; G06T 2207/30244

(57) ABSTRACT

This disclosure enables detection of change in existing map information. The information processing apparatus acquires a map of a target area, a captured image obtained by imaging the target area from above, first information in which map information representing a position of each building in the map is assigned to the captured image positionally registered with the map, second information in which a building is detected from the captured image, and association information (MR) in which the first information and the second information are associated with each other, the association information including at least any one of new building information (FN) representing a new building that is not included in the map but is included in the captured image, or renovated building information (FR) representing a renovated building in which a shape in the map is different from a shape in the captured image.

### CROSS-REFERENCE TO RELATED APPLICATIONS

The present application is a Continuation of PCT International Application No. PCT/JP 2024/025562 filed on Jul. 17, 2024 claiming priority under 35 U.S.C § 119(a) to Japanese Patent Application No. 2023-135725 filed on Aug. 23, 2023. Each of the above applications is hereby expressly incorporated by reference, in its entirety, into the present application.

### BACKGROUND OF THE INVENTION

### 1. Field of the Invention

The present invention relates to an information processing apparatus, an information processing method, a program, and an information processing system.

### 2. Description of the Related Art

A technique of accurately superimposing map information on an aerial image using the aerial image, map information, and sensor data is known. The sensor data may include a position of a camera in a case where the aerial capture is performed and a posture of the camera in a case where the aerial capture is performed.

For example, the correspondence between each building included in the captured image and an address is realized by performing registration between the captured image obtained by performing imaging with a camera mounted on a drone and the map, and by associating map information included in the map with the captured image. The association between the captured image and the map information may be referred to as matching between the captured image and the map information.

In a case where a disaster occurs, the AI assessment of determining a damage status in each building is applied to the captured image to which the map information is associated, so that the damage status of each building can be confirmed. Examples of the building include a house in which a person lives.

JP2002-297641A discloses a map data storage method of performing registration between map graphic data representing a region determined in advance and map image data obtained by imaging the region represented by the map graphic data, designating a region in which difference extraction is performed, extracting difference data representing a difference between the map graphic data and the map image data, and storing the extracted difference data. In the map data storage method disclosed in JP2002-297641A, the update work of the map graphic data is performed for the building determined as a building to be demolished, a building to be rebuilt, or a new building. The difference data is superimposed on the map graphic data and displayed on the display.

WO2022/070956A discloses an information processing apparatus that individually extracts an image of a building from a bird's-eye view image, identifies an unimaged building that is not shown in the bird's-eye view image among the buildings included in map information in which the building and an address are associated with each other, and requests a terminal that is present near the unimaged building among a plurality of terminals to perform imaging of the unimaged building.

### SUMMARY OF THE INVENTION

However, information on a new building that is newly built after the map is created is not present in the map, and the new building cannot be detected from the map. In addition, a vacant lot that is a site of a building that has been destroyed or a demolished building is detected as a vacant lot based on information that is present in the map even though the building is not present in the captured image. Further, it is difficult to detect an accurate shape of a building that has been expanded or renovated.

That is, it is difficult to reflect a change in reality after the map is created on the map information associated with the captured image, and as a result, it may be difficult to accurately associate the captured image with the map information.

In the method disclosed in JP2002-297641A, registration between the map graphic data and the map image data is performed, but the method does not disclose or suggest the association between the map graphic data and the map image data, and in the method disclosed in JP2002-297641A, it is difficult to use the map graphic data for the building in the map image data, such as information representing a position.

In the apparatus disclosed in WO2022/070956A, the address of the building included in the bird's-eye view image is identified based on the address information in which the building and the address are associated with each other for all the buildings present in the map, but the new building that is newly built after the map is created may lack the address information, and the building that is included in the bird's-eye view image may not be identified for the address.

The present invention has been made in view of such circumstances, and an object thereof is to provide an information processing apparatus, an information processing method, a program, and an information processing system that can detect a change in an existing map.

According to a first aspect of the present disclosure, there is provided an information processing apparatus comprising:
one or more processors; and
one or more memories in which a command to be executed by the one or more processors is stored,
wherein the one or more processors are configured to:
   acquire a map of a target area;
   acquire a captured image obtained by imaging the target area from above;
   acquire first information in which map information representing a position of each building in the map is assigned to the captured image positionally registered with the map;
   acquire second information in which a building is detected from the captured image; and
   acquire association information in which the first information and the second information are associated with each other, the association information including at least any one of new building information representing a new building that is not included in the map but is included in the captured image, or renovated building information representing a renovated building in which a shape in the map is different from a shape in the captured image.

According to the information processing apparatus according to the first aspect of the present disclosure, the first information in which the map information is assigned to the captured image of the target area and the second information in which the building is detected from the captured image are associated with each other, and the association information including at least any one of the new building or the renovated building is acquired. As a result, a change in the existing map can be detected.

A position of the building may be represented by an address of the building. The position of the building may be represented by a latitude and a longitude at a centroid of the building.

The association information may include a demolished house that is present in the map but is not present in the captured image.

According to a second aspect of the present disclosure, in the information processing apparatus according to the first aspect, the one or more processors are configured to display the captured image by superimposing the association information on the captured image.

A display aspect in which the association information is superimposed on the captured image may be applied to a display aspect on a display device or may be applied to printing.

According to a third aspect of the present disclosure, in the information processing apparatus according to the second aspect, the one or more processors are configured to display the captured image on which the association information is superimposed by displaying the new building information and the renovated building information in a distinguishable manner.

A frame surrounding the building may be applied to the new building information and the renovated building information. The new building information and the renovated building information may be distinguished from each other by applying a color of the frame, a type of the frame, or the like.

According to a fourth aspect of the present disclosure, in the information processing apparatus according to any one of the first to third aspects, the one or more processors are configured to display, as the association information, an image cut out from the captured image, a type, and an address for each of the new building and the renovated building.

The association information in such an aspect may be applied to a tabular list format.

According to a fifth aspect of the present disclosure, in the information processing apparatus according to any one of the first to fourth aspects, the one or more processors are configured to acquire the first information in which an address of the building is associated, as the map information, with the captured image.

According to a sixth aspect of the present disclosure, in the information processing apparatus according to the fifth aspect, the one or more processors are configured to acquire an address of the new building based on a latitude and a longitude of an existing building included in the map and the captured image and located around the new building.

According to a seventh aspect of the present disclosure, in the information processing apparatus according to any one of the first to sixth aspects, the one or more processors are configured to detect the building from the captured image by applying a trained learning model that has learned a correspondence between the captured image and the building included in the captured image.

According to an eighth aspect of the present disclosure, in the information processing apparatus according to any one of the first to seventh aspects, the one or more processors are configured to perform registration between the captured image and the map based on sensor data including a position of an imaging device applied in a case of imaging the target area and a posture of the imaging device.

According to a ninth aspect of the present disclosure, in the information processing apparatus according to any one of the first to eighth aspects, the one or more processors are configured to assign the renovated building information representing the renovated building to a building in which a shape of the building in the map is different from a shape of the building in the captured image.

According to a tenth aspect of the present disclosure, there is provided an information processing method executed by an information processing apparatus to which a computer is applied, the information processing method including:
acquiring a map of a target area;
acquiring a captured image obtained by imaging the target area from above;
acquiring first information in which map information representing a position of each building in the map is assigned to the captured image positionally registered with the map;
acquiring second information in which a building is detected from the captured image; and
acquiring association information in which the first information and the second information are associated with each other, the association information including at least any one of new building information representing a new building that is not included in the map but is included in the captured image, or renovated building information representing a renovated building in which a shape in the map is different from a shape in the captured image.

In the information processing method according to the tenth aspect, the same matters as those specified in the second to ninth aspects can be combined as appropriate. In this case, the component responsible for the specified processing or function in the information processing apparatus can be understood as a component of the information processing method responsible for the corresponding processing or function.

According to an eleventh aspect of the present disclosure, there is provided a program causing a computer to implement:
a function of acquiring a map of a target area;
a function of acquiring a captured image obtained by imaging the target area from above;
a function of acquiring first information in which map information representing a position of each building in the map is assigned to the captured image positionally registered with the map;
a function of acquiring second information in which a building is detected from the captured image; and
a function of acquiring association information in which the first information and the second information are associated with each other, the association information including at least any one of new building information representing a new building that is not included in the map but is included in the captured image, or renovated building information representing a renovated building in which a shape in the map is different from a shape in the captured image.

In the program according to the eleventh aspect, the same items as those specified in the second to ninth aspects can be combined as appropriate. In this case, the component responsible for the specified processing or function in the information processing apparatus can be understood as a component of the program responsible for the corresponding processing or function.

According to a twelfth aspect of the present disclosure, there is provided an information processing system comprising an information processing apparatus that is electrically connected for communication to a network,
in which the information processing apparatus includes
   one or more processors, and
   one or more memories in which a command to be executed by the one or more processors is stored, and
the one or more processors are configured to:
   acquire a map of a target area;
   acquire a captured image obtained by imaging the target area from above;
   acquire first information in which map information representing a position of each building in the map is assigned to the captured image positionally registered with the map;
   acquire second information in which a building is detected from the captured image; and
   acquire association information in which the first information and the second information are associated with each other, the association information including at least any one of new building information representing a new building that is not included in the map but is included in the captured image, or renovated building information representing a renovated building in which a shape in the map is different from a shape in the captured image.

In the information processing system according to the twelfth aspect, the same matters as those specified in the second to ninth aspects can be combined as appropriate. In this case, a component that performs processing or a function specified in the information processing apparatus can be understood as a component of the information processing system that performs processing or a function corresponding to the processing or the function.

The information processing system according to the twelfth aspect may comprise a remote controller that is electrically connected for communication to a network, a flying object that is remotely controlled by using the remote controller; an imaging device that is remotely controlled by using the remote controller; and a terminal apparatus that is electrically connected for communication to the network.

According to the present invention, the first information in which the map information is assigned to the captured image of the target area and the second information in which the building is detected from the captured image are associated with each other, and the association information including at least any one of the new building or the renovated building is acquired. As a result, a change in the existing map can be detected.

### BRIEF DESCRIPTION OF THE DRAWINGS

FIG. 1 is an explanatory diagram of a problem in an information processing method of a comparative example.

FIG. 2 is a schematic diagram of an information processing method according to an embodiment.

FIG. 3 is a schematic diagram showing a specific example of a processing result.

FIG. 4 is a schematic diagram showing another example of the processing result.

FIG. 5 is an explanatory diagram of an address assignment process for a newly built house.

FIG. 6 is a diagram showing a numerical expression applied to calculation of a latitude and a longitude.

FIG. 7 is a configuration diagram showing a schematic configuration of an information processing system according to the embodiment.

FIG. 8 is a functional block diagram showing an electric configuration of a drone on which a camera is mounted.

FIG. 9 is a functional block diagram showing an electric configuration of the information processing apparatus shown in FIG. 7.

FIG. 10 is a block diagram showing a hardware configuration of the information processing apparatus shown in FIG. 7.

FIG. 11 is a flowchart showing a procedure of an information processing method according to the embodiment.

### DESCRIPTION OF THE PREFERRED EMBODIMENTS

Hereinafter, preferred embodiments of the present invention will be described with reference to the accompanying drawings. In the present specification, the same components are denoted by the same reference numerals, and duplicate description thereof will be omitted as appropriate. In addition, in a case where a plurality of components are exemplified and listed, it can be interpreted as including at least one of the plurality of components.

### Problem of Information Processing Method According to Related Art

Hereinafter, information processing of associating map information included in a map of a target area with an aerial image obtained by imaging the target area from above will be described by using an example of a survey of a damage status performed by a local government such as a city, a town, or a village. The term “from above” is not limited to a distance from the ground, and may be a flight path of a drone or a helicopter or an orbit of an artificial satellite or the like.

In Japan, the map of the target area may be acquired from base map information provided by the Geospatial Information Authority of Japan or may be acquired from a database of OpenStreetMap or the like. The map information includes an address of a house displayed on the map. The map information may include a latitude and a longitude of the house displayed on the map. The address of the house displayed on the map is visualized as a frame representing an outer shape of the house having the address. The house described in the embodiment is an example of a building.

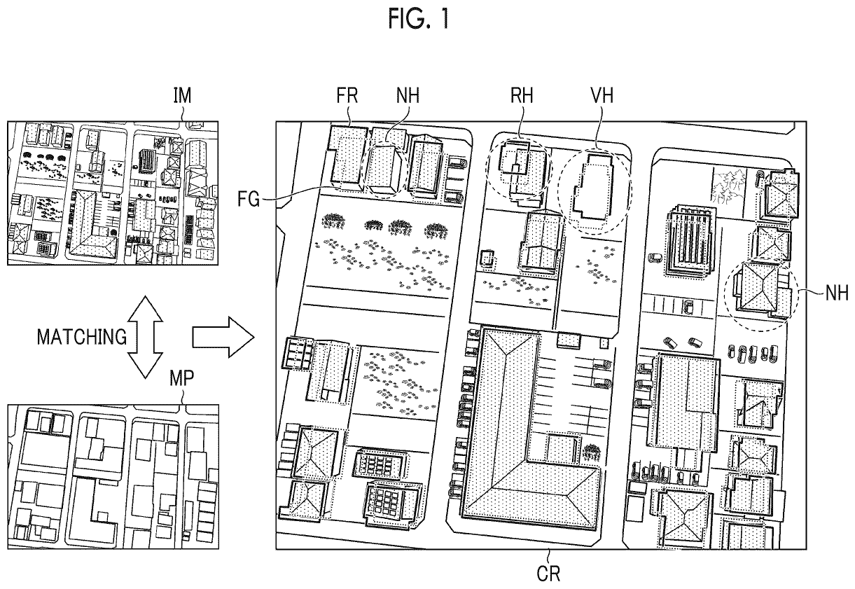

FIG. 1 is an explanatory diagram of a problem in an information processing method of a comparative example. FIG. 1 schematically shows a registration process of matching a scale and a position of a map MP to an aerial image IM and an association processing result CR of associating map information with the aerial image IM. The map information can be accurately superimposed on the aerial image IM by applying sensor data including a position of a camera used for imaging the aerial image IM and a posture of the camera. The camera described in the embodiment is an example of an imaging device.

In the association processing result CR shown in FIG. 1, a frame FG using a dashed line represents an outline of the house on the ground displayed on the map MP. In addition, in the association processing result CR, a frame FR using a solid line represents an outline of a roof of the house displayed on the map MP.

That is, in the association processing result CR shown in FIG. 1, the frame FG representing the outline of the house on the ground displayed on the map MP or the frame FR representing the outline of the roof of the house is superimposed on the aerial image IM. At least any one of the frame FG representing the outline of the house on the ground or the frame FR representing the outline of the roof of the house may be superimposed on the association processing result CR.

For example, in the damage survey of the disaster or the like, a damage assessment process is performed for each house included in the association processing result CR shown in FIG. 1, and the damage status of each house can be understood. In the damage assessment process, a damage assessment AI is applied. In the damage assessment AI, a trained learning model in which a correspondence between the captured image of the house and the damage status is learned is applied.

In the association processing result CR, the frame FG or the frame FR representing a demolished house VH that is present in the map MP but is not present in the aerial image IM is present. On the other hand, in the association processing result CR, the frame FG or the frame FR representing a newly built house NH that is not present in the map MP but is present in the aerial image IM is not present.

In the damage assessment process using the damage assessment AI or the like, it is difficult to respond to the newly built house NH in which a change occurs after the map is created, and it is difficult to understand the accurate damage status of the newly built house NH. In addition, in the damage assessment process using the damage assessment AI or the like, it is difficult to understand the accurate damage status of a renovated house RH because of a difference in shape between the frame FG or the frame FR representing the renovated house RH and the renovated house RH in the aerial image IM. Hereinafter, the information processing method for solving the above-described problem will be described.

### Information Processing Method According To Embodiment

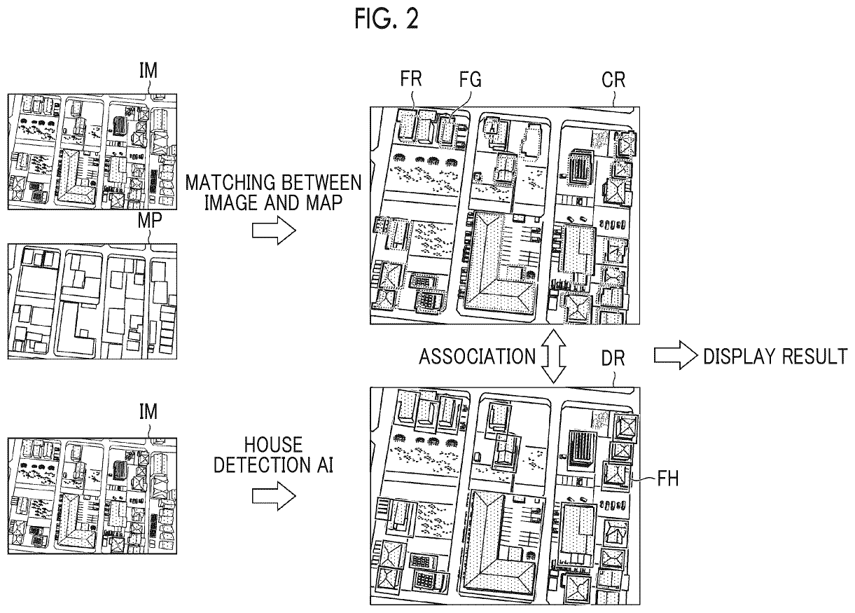

FIG. 2 is a schematic diagram of the information processing method according to the embodiment. In the information processing method according to the embodiment, the registration process of the map MP with respect to the aerial image IM and the association process of the map information with respect to the aerial image IM are combined with the house detection with respect to the aerial image IM. As a result, the information processing of extracting the newly built house NH shown in FIG. 1 is realized. In addition, the information processing of distinguishing the renovated house RH shown in FIG. 1 from the existing house is realized. The map information is associated with the house extracted in the aerial image IM, and the address is assigned to each house. The newly built house that does not have the map information and cannot be associated with the map information is separately assigned the address. Details of the assignment of the address to the newly built house will be described below.

That is, in the information processing method according to the embodiment, the association processing result CR shown in FIG. 1 is derived, and the house detection is performed on the aerial image IM to derive a house detection result DR. FIG. 2 shows an example in which a rectangular frame FH representing the outer shape of each house detected with respect to the aerial image IM is superimposed on the house detection result DR.

The house detection AI can be applied to the house detection with respect to the aerial image IM. AI is an abbreviation for artificial intelligence. The house detection AI is applied with a trained learning model that has learned the correspondence between the aerial image IM and each of one or more houses included in the aerial image IM.

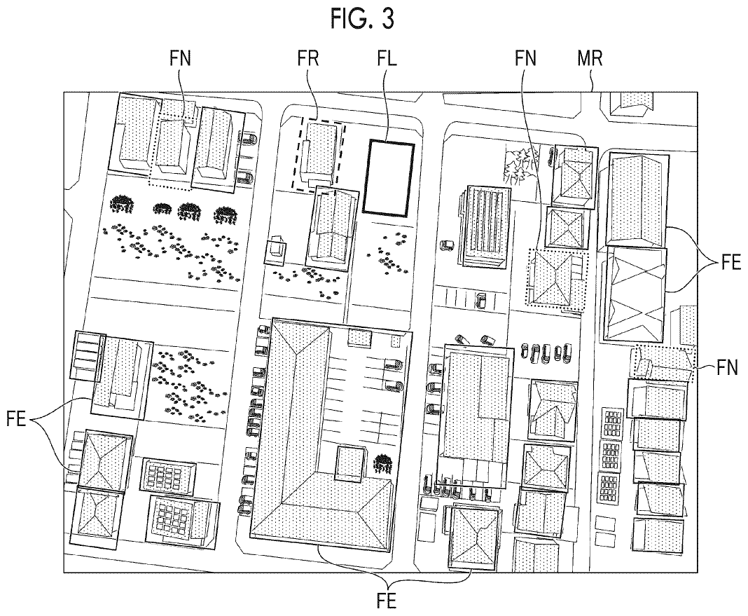

Further, in the information processing method according to the embodiment, the association process of the association processing result CR and the house detection result DR is performed. A processing result MR in which the association processing result CR and the house detection result DR are combined is shown in FIG. 3.

In the information processing method according to the embodiment, the segmentation of detecting the house region is applied to the house detection with respect to the aerial image IM, and the determination of the renovated house can be performed based on a comparison result between the shape of the house obtained by projecting the house in the map MP to the aerial image IM and the shape of the house region detected from the aerial image IM.

The association processing result CR shown in FIG. 2 is an example of the first information in which the map information representing the position of each building in the map is assigned. The house detection result DR shown in FIG. 2 is an example of the second information in which the building is detected from the captured image.

### Specific Example of Processing Result

FIG. 3 is a schematic diagram showing a specific example of the processing result. FIG. 3 shows a processing result MR in which a rectangular frame that surrounds the house and is distinguished for each type of the house is superimposed on a plurality of houses detected from the aerial image IM shown in FIG. 2. The processing result MR shown in FIG. 3 may be displayed on a display device.

In the processing result MR shown in FIG. 3, each of the plurality of houses is distinguished as an existing house, a newly built house, a renovated house, or a demolished house. The existing house is a house included in the aerial image IM and the map MP, and a shape of a house region in the aerial image IM matches a shape of a house region in the map MP. Here, the match is not a complete match, but may include a partial mismatch that occurs depending on an imaging condition of the aerial image IM or the like.

In the processing result MR shown in FIG. 3, each of the plurality of houses is surrounded by any one of a frame FE representing the existing house, a frame FN representing the newly built house, a frame FR representing the renovated house, or a frame FL representing the demolished house. A reference numeral FE is omitted for some of the existing houses.

The frame FN representing the newly built house shown in FIG. 3 is an example of the new building information representing the new building. The frame FR representing the renovated house shown in FIG. 3 is an example of the renovated building information representing the renovated building. The processing result MR shown in FIG. 3 is an example of the association information including at least any one of the new building information representing the new building or the renovated building information representing the renovated building.

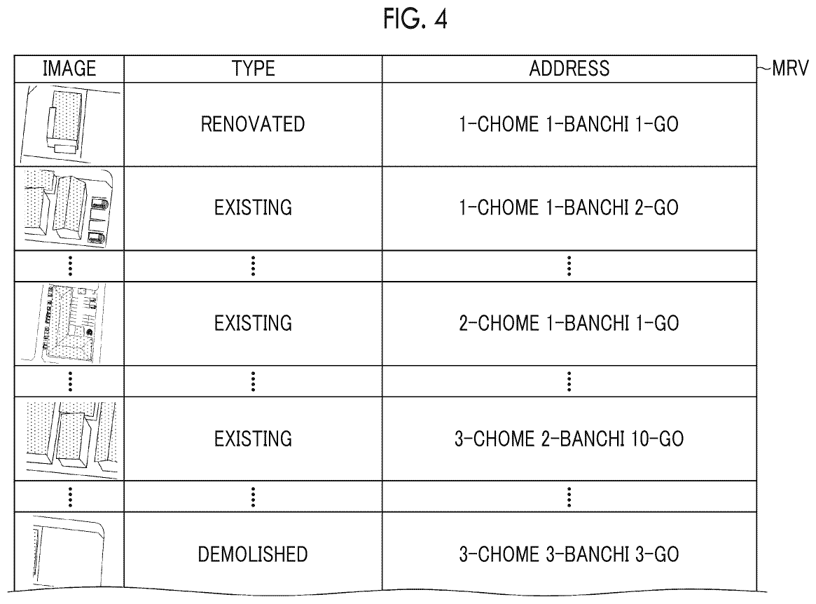

FIG. 4 is a schematic diagram showing another example of the processing result. FIG. 4 shows a processing result MRV in which an image, a type, and an address of each house are output as a tabular list. Examples of the output include display on the display device and printing.

An image field for the processing result MRV according to the other example shown in FIG. 4 displays an image of each house cut out from the aerial image IM. An image field for the demolished house may display a region, such as a vacant lot, corresponding to a demolished house in a case of capturing the aerial image IM, or may be left blank.

A type field is applied with any one of existing, newly built, renovated, or demolished. An address assigned due to the association with the map information for each house is applied to an address field. In the table shown in FIG. 4, the block code indicating chome and banchi and the house number indicating go are arbitrary numbers. The address field shown in FIG. 4 does not include a prefecture name, a municipality name, and a town name, but may include the municipality name, the town name, and the like.

In FIG. 4, the processing result MRV including the demolished house is shown, but the processing result MRV may omit the demolished house, and processing such as a hatched overlay may be applied to the demolished house.

### Specific Example of Address Assignment Process for Newly Built House

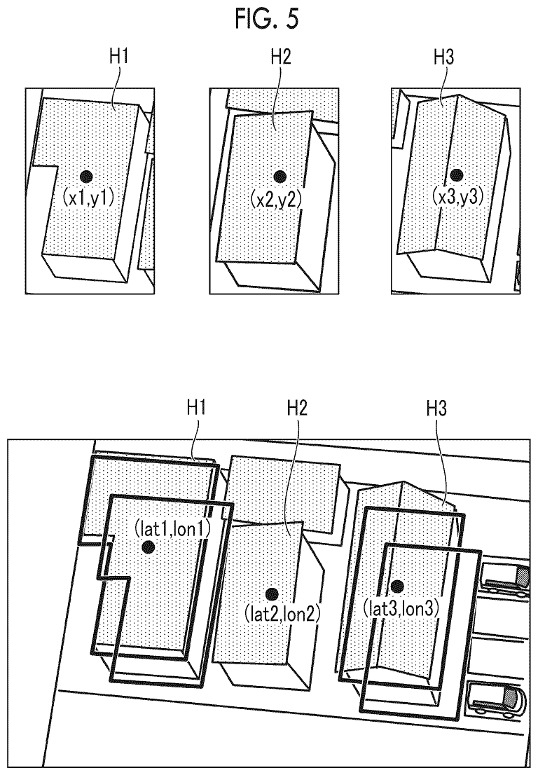

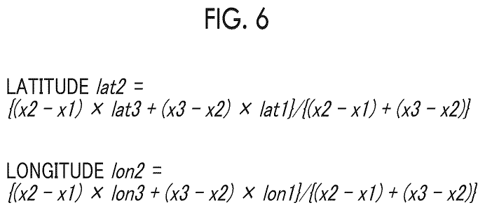

FIG. 5 is an explanatory diagram of an address assignment process for the newly built house. FIG. 6 is a diagram showing a numerical expression applied to calculation of a latitude and a longitude. The upper part of FIG. 5 shows coordinate values in the plurality of houses included in the aerial image IM shown in FIG. 2. The lower part of FIG. 5 shows the latitude and the longitude of the plurality of houses shown in the upper part of FIG. 5.

In the house included in the aerial image IM, the latitude and the longitude included in the map information are specified for the existing house in which the map information is present. On the other hand, the latitude and the longitude of the newly built house in which the corresponding map information is not present are unknown, but the latitude and the longitude of the newly built house can be calculated based on the latitude and the longitude of the existing house around the newly built house. The existing house around here is an existing house within a defined range of a distance from the newly built house of interest, and examples thereof include an existing house adjacent to the newly built house of interest.

The latitude and the longitude of the house are applied to the latitude and the longitude at the centroid of the house. The centroid of the house can be applied to the geometric centroid of a planar shape of the house in the aerial image IM. The planar shape of the house can be applied to a shape in a case where the house is projected onto the ground in the aerial image IM.

A two-dimensional orthogonal coordinate system is set for the aerial image IM, and coordinate values of a first house H1 are set to (x1, y1), coordinate values of a second house H2 are set to (x2, y2), and coordinate values of a third house H3 are set to (x3, y3).

The latitude of the first house H1 is set to lat1, and the longitude of the first house H1 is set to lon1. In addition, the latitude of the second house H2 is set to lat2, and the longitude of the second house H2 is set to lon2. Further, the latitude of the third house H3 is set to lat3, and the longitude of the third house H3 is set to lon3. The latitude lat2 of the second house H2 and the longitude lon2 of the second house H2 are represented by the numerical expression shown in FIG. 6.

The address of the newly built house of interest is acquired from the latitude and the longitude of the newly built house of interest calculated using the numerical expression shown in FIG. 6. For example, a distance from the existing house around and a direction with respect to the existing house around are understood from the latitude and the longitude of the newly built house of interest and the latitude and the longitude of the existing house around. Based on the addresses of surrounding existing houses, and on the distance to and direction with respect to the surrounding existing houses, the address of the target newly built house may be estimated. The existing house described in the embodiment is an example of an existing building.

### Configuration Example of Information Processing System According to Embodiment

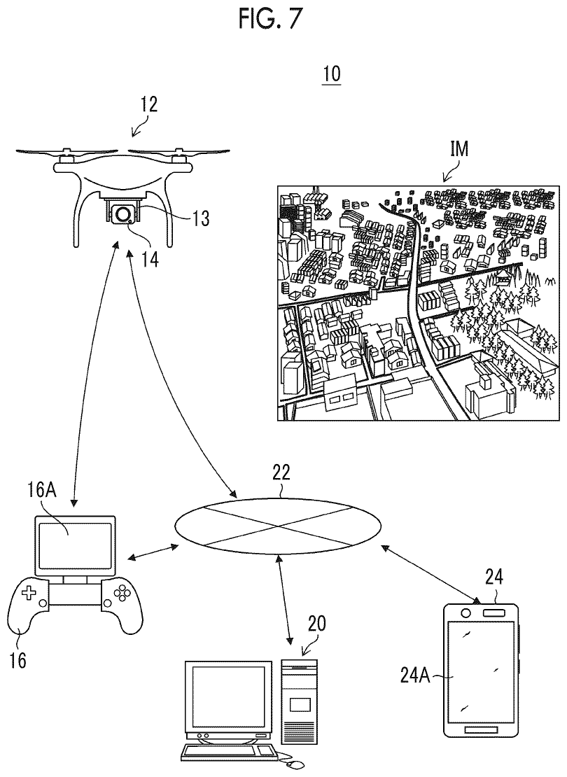

FIG. 7 is a configuration diagram showing a schematic configuration of the information processing system according to the embodiment. An information processing system 10 shown in FIG. 7 comprises a drone 12, a camera 14, a remote controller 16, and an information processing apparatus 20.

The remote controller 16 and the information processing apparatus 20 are electrically connected for communication to each other via a network 22. In addition, the information processing apparatus 20 is electrically connected for communication to a terminal apparatus 24 via the network 22. Access from a plurality of terminal apparatus 24 different from each other may be allowed in the network 22.

The drone 12 is a flying object for aerial imaging and is an unmanned aerial vehicle that is remotely operated by using the remote controller 16. The drone 12 may have an auto-pilot function of flying in accordance with a program.

The camera 14 is mounted on the drone 12 via a gimbal head 13. The camera 14 images a region to be imaged from above. The camera 14 comprises an optical system, an image sensor, and a signal processing circuit. The optical system, the image sensor, and the signal processing circuit are not shown.

The optical system comprises one or more lenses such as a focus lens. A CCD image sensor, a CMOS image sensor, or the like can be applied to the image sensor. Note that CCD is an abbreviation for Charge Coupled Device. CMOS is an abbreviation for Complementary Metal-Oxide Semiconductor.

The camera 14 processes a signal output from the image sensor by using the signal processing circuit to generate digital image data of the imaging target. The digital image data generated by using the camera 14 can be the captured image. The captured image generated by using the camera 14 may be stored in at least any of an internal storage built in the drone 12 or a storage device such as a memory card that is attachably and detachably mounted on the drone 12. In addition, the captured image generated by using the camera 14 may be transmitted to at least any of the remote controller 16, the information processing apparatus 20, or the terminal apparatus 24 by applying wireless communication. The aerial image IM shown in FIG. 7 is an example of the captured image generated by using the camera 14.

The remote controller 16 is a control device that controls the operation of the camera 14 and the drone 12 by applying wireless communication. A format of the wireless communication may be a format of a wireless LAN, a communication format using radio waves in a 2.4 gigahertz band or a 5.7 gigahertz band, or a format using a mobile communication network. A communication format for a control signal during operation of the drone 12 may differ from a communication format in a case of transmitting the captured image or the like generated by using the camera 14, or may be unified.

The remote controller 16 comprises a left-right stick used for a flight operation of the drone 12, a lever used for an operation of the gimbal head 13, an imaging button used for imaging with the camera 14, and an imaging mode button for switching between video capture and still-image capture. A touch panel display may be adopted for a display 16A provided in the remote controller 16, and an operation button such as the imaging button may be realized by using the touch panel display.

The live video generated by using the camera 14 can be displayed by using the display 16A. The remote controller 16 can understand a body status of the drone 12, such as a flight position and a flight speed of the drone 12, in real time based on an output signal of various sensors provided in the drone 12. The remote controller 16 can display the body status of the drone 12 by using the display 16A.

A computer is applied to the information processing apparatus 20. The computer may be a personal computer, a server, or a workstation. The computer may be a virtual machine.

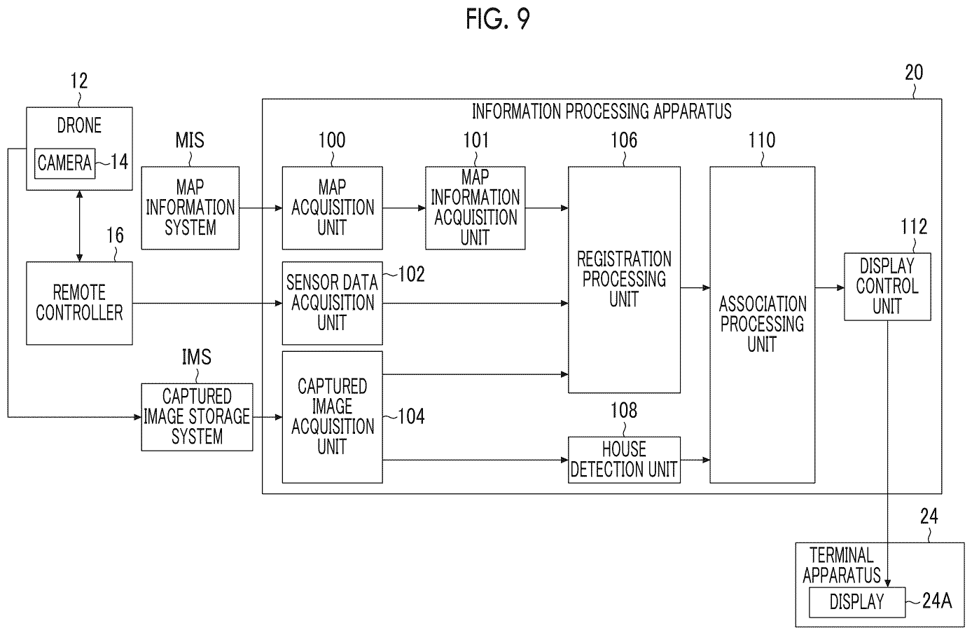

The information processing apparatus 20 can acquire the map of the target area from a map information system via the network 22. The map includes map information including an address, a latitude, and a longitude of a house or the like displayed on the map. In a case where the imaging of the target area is performed by using the camera 14, the information processing apparatus 20 may acquire the map before the imaging, or may acquire the map during or after the imaging. The map information system is denoted by a reference numeral MIS and is shown in FIG. 9.

The terminal apparatus 24 may be a portable information terminal such as a smartphone, a tablet terminal, or a portable computer. The terminal apparatus 24 comprises a display 24A. The terminal apparatus 24 may have a function of the remote controller 16. In addition, the terminal apparatus 24 may have a function of the information processing apparatus 20.

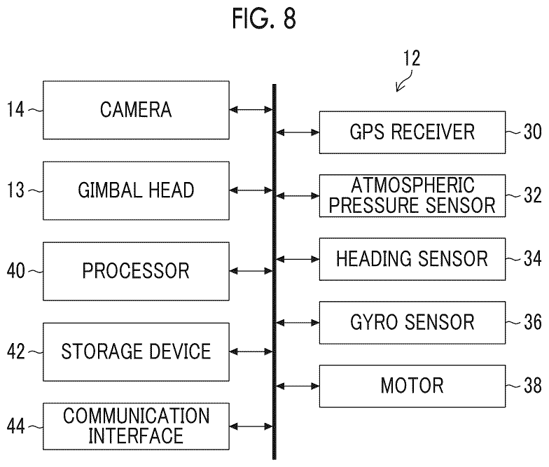

FIG. 8 is a functional block diagram showing an electric configuration of a drone on which a camera is mounted. The drone 12 comprises a GPS receiver 30. The GPS receiver 30 acquires position information including the latitude and the longitude of the drone 12. Note that GPS is an abbreviation for Global Positioning System.

The drone 12 comprises various sensors such as an atmospheric pressure sensor 32, a heading sensor 34, and a gyro sensor 36. The atmospheric pressure sensor 32 detects an atmospheric pressure in the drone 12. The drone 12 can acquire the altitude of the drone 12 based on the atmospheric pressure detected by using the atmospheric pressure sensor 32. The term “acquire” in the present specification may include a concept in which information is generated by applying data processing such as calculation. The latitude, the longitude, and the altitude of the drone 12 constitute the position information of the drone 12 and the camera 14.

A geomagnetic sensor can be applied to the heading sensor 34. The heading sensor 34 detects a direction in which a lens of the camera 14 faces.

The gyro sensor 36 detects a roll angle indicating a rotation angle with respect to a roll axis, a pitch angle indicating a rotation angle with respect to a pitch axis, and a yaw angle indicating a rotation angle with respect to a yaw axis. The drone 12 acquires posture information representing a posture of the drone 12 based on the roll angle, the pitch angle, and the yaw angle detected by the gyro sensor 36. Various sensors such as the atmospheric pressure sensor 32, the heading sensor 34, and the gyro sensor 36 may be provided in the camera 14.

The drone 12 comprises a processor 40, a storage device 42, and a communication interface 44. The processor 40 functions as a flight controller that performs calculation necessary for flight control of the drone 12 based on the sensor data obtained from the various sensors. As the storage device 42, a memory, an internal storage, an external storage, or the like can be applied. The storage device 42 may be configured by appropriately combining a memory or the like.

The communication interface 44 functions as a communication device that performs wireless communication with the remote controller 16 or the like shown in FIG. 7. The communication interface 44 may comprise a communication terminal corresponding to wired communication.

The drone 12 comprises a battery and a battery charging terminal. The battery and the battery charging terminal are not shown in drawings.

### Electric Configuration of Information Processing Apparatus

FIG. 9 is a functional block diagram showing an electric configuration of the information processing apparatus shown in FIG. 7. The information processing apparatus 20 comprises a map acquisition unit 100. The map acquisition unit 100 acquires the map MP of the target area from the map information system MIS. The map acquisition unit 100 may acquire a large-scale map including the map MP of the target area. For example, in a case where the target area is defined in units of chome, the map acquisition unit 100 may acquire a map including one or more chomes adjacent to the chome of the target area and different from the target area.

The information processing apparatus 20 comprises a map information acquisition unit 101. The map information acquisition unit 101 acquires the map information included in the map MP acquired by using the map acquisition unit 100. The map information acquisition unit 101 may be configured integrally with the map acquisition unit 100. That is, the map acquisition unit 100 may acquire the map MP and acquire the map information from the acquired map MP.

The information processing apparatus 20 comprises a sensor data acquisition unit 102. The sensor data acquisition unit 102 acquires the sensor data from the remote controller 16. For example, the information processing apparatus 20 may transmit a signal for requesting the acquisition of the sensor data to the remote controller 16 and acquire the sensor data transmitted from the remote controller 16 in response to the request. The information processing apparatus 20 may acquire the sensor data from the drone 12.

The information processing apparatus 20 comprises a captured image acquisition unit 104. The captured image acquisition unit 104 acquires the aerial image IM of the target area that is captured by using the camera 14, generated, and stored in the captured image storage system IMS, from the captured image storage system IMS. The information processing apparatus 20 may acquire the aerial image IM of the target area from the camera 14.

The information processing apparatus 20 comprises a registration processing unit 106. The registration processing unit 106 performs the registration processing of the map MP acquired by using the map acquisition unit 100 and the aerial image IM acquired by using the captured image acquisition unit 104 with reference to the sensor data acquired by using the sensor data acquisition unit 102. The registration processing unit 106 performs scale matching processing of matching a scale of the map MP and a scale of the aerial image IM in a case of positionally registering the map MP and the aerial image IM.

The information processing apparatus 20 comprises a house detection unit 108. The house detection unit 108 detects the house from the captured image acquired by using the captured image acquisition unit 104. A trained learning model that has learned a correspondence between the aerial image IM and the house can be applied to the house detection unit 108. The trained learning model may be referred to as house detection AI.

The information processing apparatus 20 comprises an association processing unit 110. The association processing unit 110 associates the map information of the house displayed on the map MP with the house detected from the aerial image IM. For example, the association processing unit 110 assigns the address to each house included in the aerial image IM.

The information processing apparatus 20 comprises a display control unit 112. The display control unit 112 generates a display signal representing the captured image to which the map information is associated, and transmits the display signal to the display device. Examples of the display device include the display 24A provided in the terminal apparatus 24.

### Hardware Configuration of Information Processing Apparatus

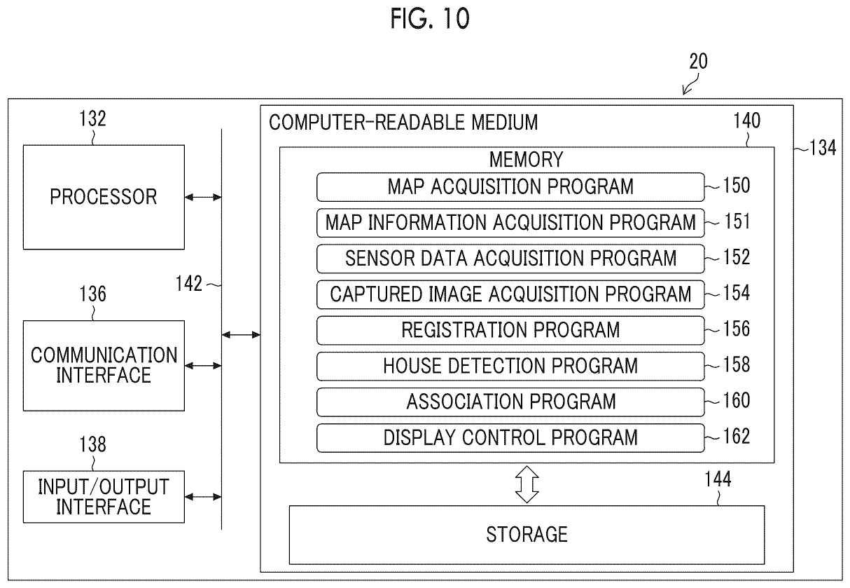

FIG. 10 is a block diagram showing a hardware configuration of the information processing apparatus shown in FIG. 7. The information processing apparatus 20 comprises one or more processors 132 and one or more computer-readable media 134. The information processing apparatus 20 comprises a communication interface 136 and an input/output interface 138.

The processor 132 executes various programs stored in the memory 140 of the computer-readable medium 134 to implement various functions of the information processing apparatus 20. The processor 132 includes a central processing unit (CPU). The processor 132 may include a graphics processing unit (GPU). The processor 132 is connected to the computer-readable medium 134, the communication interface 136, and the input/output interface 138 via a bus 142.

The computer-readable medium 134 includes a memory 140 which is a main storage device and a storage 144 which is an auxiliary storage device. A semiconductor memory, a hard disk device, a solid state drive device, and the like may be applied as the computer-readable medium 134. Any combination of a plurality of devices may be applied as the computer-readable medium 134.

The hard disk device can be referred to as an HDD which is an abbreviation for a hard disk drive. The solid state drive device can be referred to as an SSD which is an abbreviation for a solid state drive.

The memory 140 of the computer-readable medium 134 stores a map acquisition program 150, a map information acquisition program 151, a sensor data acquisition program 152, a captured image acquisition program 154, a registration program 156, a house detection program 158, an association program 160, and a display control program 162.

The map acquisition program 150 is applied to the map acquisition unit 100 shown in FIG. 9 to implement a map acquisition function. The map information acquisition program 151 is applied to the map information acquisition unit 101 to implement a map information acquisition function.

The sensor data acquisition program 152 is applied to the sensor data acquisition unit 102 to implement a sensor data acquisition function. The captured image acquisition program 154 is applied to the captured image acquisition unit 104 to implement a captured image acquisition function.

The registration program 156 is applied to the registration processing unit 106 to implement a registration function of the map MP and the aerial image IM. The registration program 156 may implement a scale matching function of matching the scale of the map MP and the scale of the aerial image IM. The memory 140 may be provided with a scale matching program separately from the registration program 156.

The house detection program 158 is applied to the house detection unit 108 to implement a house detection function. The house detection program 158 may be configured as a trained learning model that has learned a correspondence between the aerial image IM and the house.

The association program 160 is applied to the association processing unit 110 to implement an association function of associating the map information of the house displayed on the map MP with the house detected from the aerial image IM and assigning the address to each house.

The display control program 162 is applied to the display control unit 112 to implement a display control function. That is, the display control program 162 implements a display signal generation function of generating the display signal and a display signal output function of transmitting the display signal to the display device.

Various programs stored in the computer-readable medium 134 include one or more instructions. The computer-readable medium 134 stores various kinds of data, various parameters, and the like. The term “program” is synonymous with the term “software”.

A hardware structure of the processor 132 is various processors as described below. The various processors include a CPU that is a general-purpose processor that executes software (program) to act as various functional units, a GPU that is a processor specialized in image processing, a programmable logic device (PLD) that is a processor of which a circuit configuration can be changed after manufacture, such as a field programmable gate array (FPGA), and a dedicated electric circuit that is a processor having a circuit configuration dedicatedly designed to execute specific processing, such as an application specific integrated circuit (ASIC).

One processing unit may be configured by one of the various types of processors or may be configured by the same type or different types of two or more processors (for example, a plurality of FPGAs, a combination of a CPU and an FPGA, or a combination of a CPU and a GPU). In addition, one processor may configure a plurality of functional units. As an example of configuring a plurality of functional units by one processor, first, there is a form in which one processor is configured by a combination of one or more CPUs and software and the processor acts as the plurality of functional units, as represented by a computer such as a client and a server. Second, there is a form in which a processor that implements functions of the entire system including a plurality of functional units with one integrated circuit (IC) chip is used, as represented by a system on chip (SoC) or the like. As described above, the various types of functional units are configured by one or more of the various types of processors used as a hardware structure.

Furthermore, the hardware structure of these various processors is, more specifically, an electrical circuit (circuitry) in which circuit elements such as semiconductor elements are combined.

The memory 140 stores a command to be executed by the processor 132. The memory 140 includes a random access memory (RAM) and a read only memory (ROM), neither of which is shown in drawings. The processor 132 executes various types of processing of the information processing apparatus 20 by using the RAM as a work area, executing software by using various programs and parameters including the map acquisition program 150 and the like stored in the ROM, and using the parameters stored in the ROM or the like.

### Procedure of Information Processing Method

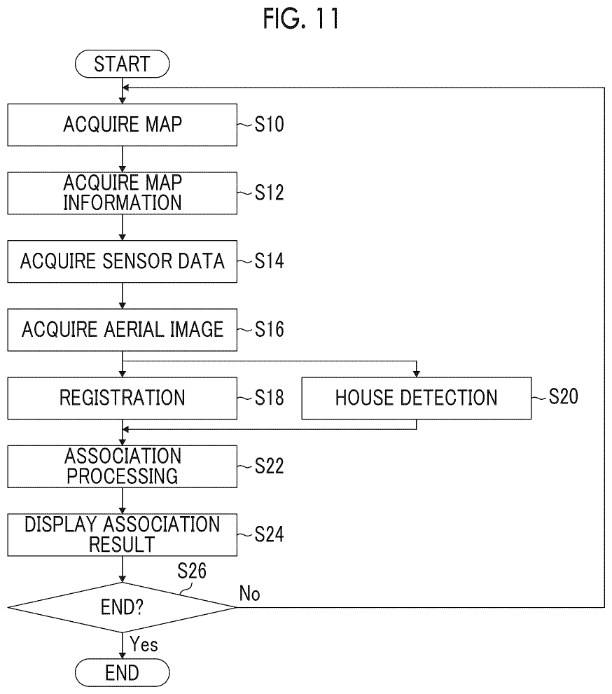

FIG. 11 is a flowchart showing a procedure of the information processing method according to the embodiment. Each step of the information processing method shown in FIG. 11 is executed by using various processing units provided in the information processing apparatus 20 to which the computer is applied.

In a map acquisition step S10, the map acquisition unit 100 shown in FIG. 9 acquires the map MP. After the map acquisition step S10, the process proceeds to a map information acquisition step S12. In the map information acquisition step S12, the map information acquisition unit 101 acquires the map information from the map MP acquired in the map acquisition step S10. After the map information acquisition step S12, the process proceeds to a sensor data acquisition step S14.

In the sensor data acquisition step S14, the sensor data acquisition unit 102 acquires the sensor data from the remote controller 16. After the sensor data acquisition step S14, the process proceeds to an aerial image acquisition step S16.

In the aerial image acquisition step S16, the captured image acquisition unit 104 acquires the aerial image IM from the captured image storage system IMS. After the aerial image acquisition step S16, the process proceeds to a registration step S18 and a house detection step S20.

In the registration step S18, the registration processing unit 106 executes the registration processing of the map MP and the aerial image IM. In the registration step S18, the processing of matching the scale of the map MP and the aerial image IM may be executed, and then the processing of positionally registering the map MP and the aerial image IM may be executed. After the registration step S18, the process proceeds to an association processing step S22.

In the house detection step S20, the house detection unit 108 detects the house from the aerial image IM. In addition, in the house detection step S20, it is determined whether the house detected from the aerial image IM is the existing house or the renovated house.

Specifically, in the house detection step S20, the segmentation of detecting the house region is performed on the aerial image IM. Next, a first house shape of the house in the map MP projected onto the aerial image IM and a second house shape of the house region extracted from the aerial image IM are compared.

The house in which the first house shape and the second house shape match is determined as the existing house, and existing house information representing that the house is the existing house is assigned. On the other hand, the house in which the first house shape and the second house shape are different is determined as the renovated house, and renovated house information representing that the house is the renovated house is assigned.

After the house detection step S20, the process proceeds to the association processing step S22. The house detection step S20 may be executed after the aerial image IM is acquired in the aerial image acquisition step S16, and may be executed in parallel with the registration step S18, for example. The house detection step S20 may be executed before the registration step S18 or after the registration step S18.

In the association processing step S22, the association processing unit 110 associates the map information acquired in the map information acquisition step S12 with the house detected in the house detection step S20. For example, in the association processing step S22, the address is assigned to the existing house and the renovated house.

In addition, in the association processing step S22, the newly built house is detected, and the address is assigned to the newly built house. Further, in the association processing step S22, newly built house information representing that the house is the newly built house is assigned to the newly built house. After the association processing step S22, the process proceeds to an association result display step S24.

In the association result display step S24, the display control unit 112 generates a display signal representing the processing result of the association processing step S22, transmits the generated display signal to the display device, and displays the association processing result by using the display device. After the association result display step S24, the process proceeds to an end determination step S26.

In the end determination step S26, the information processing apparatus 20 determines whether or not a defined end condition is satisfied. In the end determination step S26, in a case where it is determined that the defined end condition is not satisfied, a No determination is made. In a case of the No determination, the process returns to the map acquisition step S10, and each step from the map acquisition step S10 to the end determination step S26 is repeatedly executed until the Yes determination is made in the end determination step S26.

On the other hand, in the end determination step S26, in a case where it is determined that the defined end condition is satisfied, a Yes determination is made. In a case of the Yes determination, the defined end processing is executed, and the procedure of the information processing apparatus ends.

### Effects of Embodiment

The information processing apparatus and the information processing method according to the embodiment can obtain the following effects.

### 1

The map information is acquired from the map MP of the target area. The house is detected from the aerial image IM of the target area. The map of the target area and the aerial image of the target area are associated with each other, and information on the newly built house and information on the renovated house in the aerial image IM are acquired. As a result, a change in the target area after the map MP is created can be detected.

### 2

The latitude of the newly built house is calculated based on the latitude of the existing house. The longitude of the newly built house is calculated based on the longitude of the existing house. The address of the newly built house is acquired based on the calculated latitude and longitude of the newly built house by reference to the address of the existing house. As a result, the newly built house in the aerial image IM is detected, and the address is assigned to the newly built house.

### 3

The segmentation of detecting the house region is applied to the house detection. The first house shape representing the shape of the house in the map MP projected onto the aerial image IM and the second house shape representing the shape of the house region detected from the aerial image IM are compared. The house in which the first house shape and the second house shape are different is determined as the renovated house. As a result, the renovated house in the aerial image IM is detected.

### 4

The existing house, the newly built house, and the renovated house are distinguished from each other and are displayed on the display device for the aerial image IM. As a result, the existing house, the newly built house, and the renovated house are visualized in the aerial image IM.

The technical scope of the present invention is not limited to the scope described in the above-described embodiment. The configurations and the like in each embodiment can be appropriately combined between the respective embodiments without departing from the spirit of the present invention.

### EXPLANATION OF REFERENCES

10: information processing system
12: drone
13: gimbal head
14: camera
16: remote controller
16A: display
20: information processing apparatus
22: network
24: terminal apparatus
24A: display
30: GPS receiver
32: atmospheric pressure sensor
34: heading sensor
36: gyro sensor
38: motor
40: processor
42: storage device
44: communication interface
100: map acquisition unit
101: map information acquisition unit
102: sensor data acquisition unit
104: captured image acquisition unit
106: registration processing unit
108: house detection unit
110: association processing unit
112: display control unit
132: processor
134: computer-readable medium
136: communication interface
138: input/output interface
140: memory
142: bus
144: storage
150: map acquisition program
151: map information acquisition program
152: sensor data acquisition program
154: captured image acquisition program
156: registration program
158: house detection program
160: association program
162: display control program
CR: association processing result
DR: house detection result
FE: frame representing existing house
FL: frame representing demolished house
FN: frame representing newly built house
FR: frame representing renovated house
H1: first house
H2: second house
H3: third house
IM: aerial image
MP: map
MR: processing result
MRV: processing result
NH: newly built house
S10 to S26: each step of information processing method

What is claimed is:

1. An information processing apparatus comprising:
one or more processors; and
one or more memories in which a command to be executed by the one or more processors is stored,
wherein the one or more processors are configured to:
acquire a map of a target area;
acquire a captured image obtained by imaging the target area from above;
acquire first information in which map information representing a position of each building in the map is assigned to the captured image positionally registered with the map;
acquire second information in which a building is detected from the captured image; and
acquire association information in which the first information and the second information are associated with each other, the association information including at least any one of new building information representing a new building that is not included in the map but is included in the captured image, or renovated building information representing a renovated building in which a shape in the map is different from a shape in the captured image.

2. The information processing apparatus according to claim 1,
wherein the one or more processors are configured to display the captured image by superimposing the association information on the captured image.

3. The information processing apparatus according to claim 2,
wherein the one or more processors are configured to display the captured image on which the association information is superimposed by displaying the new building information and the renovated building information in a distinguishable manner.

4. The information processing apparatus according to claim 1,
wherein the one or more processors are configured to display, as the association information, an image cut out from the captured image, a type, and an address for each of the new building and the renovated building.

5. The information processing apparatus according to claim 1,
wherein the one or more processors are configured to acquire the first information in which an address of the building is associated, as the map information, with the captured image.

6. The information processing apparatus according to claim 5,
wherein the one or more processors are configured to acquire an address of the new building based on a latitude and a longitude of an existing building included in the map and the captured image and located around the new building.

7. The information processing apparatus according to claim 1,
wherein the one or more processors are configured to detect the building from the captured image by applying a trained learning model that has learned a correspondence between the captured image and the building included in the captured image.

8. The information processing apparatus according to claim 1,
wherein the one or more processors are configured to perform registration between the captured image and the map based on sensor data including a position of an imaging device applied in a case of imaging the target area and a posture of the imaging device.

9. The information processing apparatus according to claim 1,
wherein the one or more processors are configured to assign the renovated building information representing the renovated building to a building in which a shape of the building in the map is different from a shape of the building in the captured image.

10. An information processing method executed by an information processing apparatus to which a computer is applied, the information processing method comprising:
acquiring a map of a target area;
acquiring a captured image obtained by imaging the target area from above;
acquiring first information in which map information representing a position of each building in the map is assigned to the captured image positionally registered with the map;
acquiring second information in which a building is detected from the captured image; and
acquiring association information in which the first information and the second information are associated with each other, the association information including at least any one of new building information representing a new building that is not included in the map but is included in the captured image, or renovated building information representing a renovated building in which a shape in the map is different from a shape in the captured image.

11. A non-transitory, computer-readable tangible recording medium on which a program for causing a computer to implement:
a function of acquiring a map of a target area;
a function of acquiring a captured image obtained by imaging the target area from above;
a function of acquiring first information in which map information representing a position of each building in the map is assigned to the captured image positionally registered with the map;
a function of acquiring second information in which a building is detected from the captured image; and
a function of acquiring association information in which the first information and the second information are associated with each other, the association information including at least any one of new building information representing a new building that is not included in the map but is included in the captured image, or renovated building information representing a renovated building in which a shape in the map is different from a shape in the captured image.

12. An information processing system comprising an information processing apparatus according to claim 1, that is electrically connected for communication to a network.
